(19) United States
(12) Patent Application Publication
(10) Pub. No.: US 2024/0148183 A1
(43) Pub. Date: May 9, 2024

(54) HEATING AND COOLING BEVERAGE CONTAINER

(71) Applicant: GIFTEDNESS AND CREATIVITY COMPANY, SAFAT (KW)

(72) Inventor: BARRAK M O B S H ALBAZALI, SAFAT (KW)

(21) Appl. No.: 17/981,259

(22) Filed: Nov. 4, 2022

(51) Int. Cl. A47G 19/22

(52) U.S. Cl. CPC A47G 19/2288; A47G 19/2205

(57) ABSTRACT

The heating and cooling beverage container is an insulated beverage container for holding beverages with the additional capability of heating or cooling the beverage to a desired temperature. The heating and cooling beverage container includes a container body having at least one sidewall, an open upper end and a closed lower end. An inner wall is mounted within the container body and divides the container body into an upper portion and a lower portion. A thermoelectric heat pump is mounted in the lower portion of the container body. At least one battery and a controller are mounted within the lower portion of the container body. The at least one battery is in electrical communication with the thermoelectric heat pump through the controller, such that the controller can selectively switch polarity of the thermoelectric heat pump to selectively alternate between heating and cooling in the lower portion of the container body.

### BACKGROUND

### 1. Field

The disclosure of the present patent application relates to beverage containers, and particularly to a heating and cooling beverage container that selectively heats or cools a beverage to a desired temperature.

### 2. Description of the Related Art

Beverage containers with the ability to either heat or cool beverages are known. Such containers, though, are typically configured such that they must rely on an external device, such as a heating and cooling cup holder, or in such a way that they have an unconventional shape or size due to the added temperature controlling components. It would clearly be desirable to be able to integrate temperature controlling components into a beverage container with the size and shape of a conventional beverage container, thus providing additional temperature controlling capability without adding difficulty in the transport, storage or holding of the beverage container. Thus, a heating and cooling beverage container solving the aforementioned problems is desired.

### SUMMARY

The heating and cooling beverage container is an insulated beverage container for holding both hot and cold beverages with the additional capability of heating or cooling the beverage to a desired temperature. The heating and cooling beverage container includes a container body having at least one sidewall, an open upper end and a closed lower end. An inner wall is mounted within the container body and divides the container body into an upper portion and a lower portion. The inner wall defines the bottom of the upper portion, which serves as the receptacle for the beverage.

A thermoelectric heat pump, such as a Peltier device or the like, is mounted in the lower portion of the container body. At least one battery and a controller are also mounted within the lower portion of the container body. The at least one battery is in electrical communication with the thermoelectric heat pump through the controller, such that the controller can selectively switch polarity of the thermoelectric heat pump to selectively alternate between heating and cooling of the lower portion of the container body. A heat exchanger may be in thermal contact with the thermoelectric heat pump for heat exchange with the ambient environment. The heat exchange may be further effected by a fan mounted on the container body adjacent the heat exchanger.

A charging port may be mounted on the container body in electrical communication with the at least one battery for the recharging thereof. At least one upper temperature sensor may be mounted on the upper portion of the container body. The at least one upper temperature sensor is in electrical communication with the controller, such that the controller may control operation of the thermoelectric heat pump based on feedback from the at least one upper temperature sensor to maintain a temperature of the upper portion within a desired temperature range. Additionally, at least one lower temperature sensor may be mounted on the lower portion of the container body. The at least one lower temperature sensor is also in electrical communication with the controller, such that the controller may control operation of the thermoelectric heat pump based on feedback from the at least one lower temperature sensor to maintain a temperature of the lower portion within a desired temperature range.

An interface may be mounted on the container body, in electrical communication with the controller, allowing the user to input control parameters, such as basic on-off operations and desired temperatures for the beverage contained in the upper portion.

These and other features of the present subject matter will become readily apparent upon further review of the following specification.

### BRIEF DESCRIPTION OF THE DRAWINGS

FIG. 1 is a perspective view of a heating and cooling beverage container.

FIG. 2 is a perspective view of the heating and cooling beverage container of FIG. 1, shown with the outer wall of the container partially broken away to show internal components thereof.

FIG. 3 is an exploded perspective view of the heating and cooling beverage container of FIG. 1.

FIG. 4 is a block diagram showing components of the heating and cooling beverage container.

Similar reference characters denote corresponding features consistently throughout the attached drawings.

### DETAILED DESCRIPTION OF THE PREFERRED EMBODIMENTS

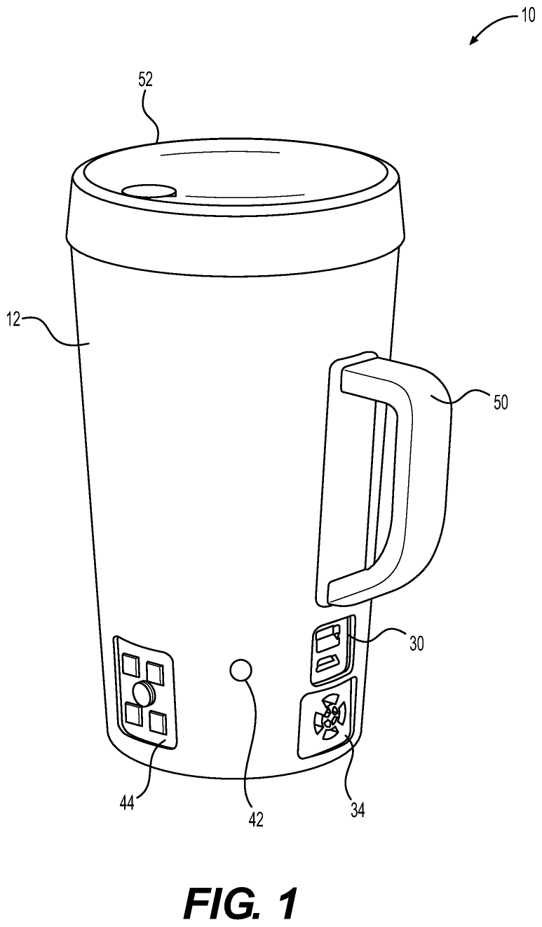

The heating and cooling beverage container 10 is an insulated beverage container for optionally holding hot or cold beverages, with the additional capability of heating or cooling the beverage to a desired temperature. As shown in FIGS. 1-3, the heating and cooling beverage container 10 includes a container body 12 having at least one sidewall 14, an open upper end 16 and a closed lower end 18. An inner partition wall 19 is mounted within the container body 12 and divides the container body 12 into an upper portion 20 and a lower portion 22. The inner partition wall 19 defines the bottom of the upper portion 20, which serves as the receptacle for the beverage. It should be understood that the container body 12 is shown in FIGS. 1-3 for exemplary purposes only and may have any desired dimensions and configuration.

It should be understood that the container body 12 may be formed from any suitable type of material. For example, the container body 12 may be formed as a dual-layer body with a hard plastic outer shell and an inner layer of stainless steel. Additionally, it should be understood that the heating and cooling beverage container 10 may also include any additional elements common to insulating beverage containers and the like, such as an exemplary handle 50 and exemplary removable lid 52 for releasably covering and sealing the open upper end 16.

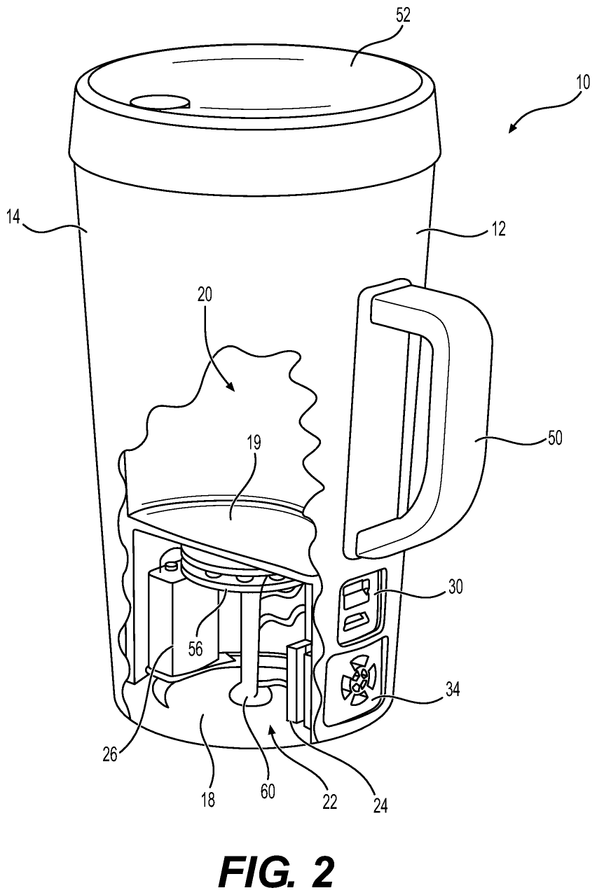

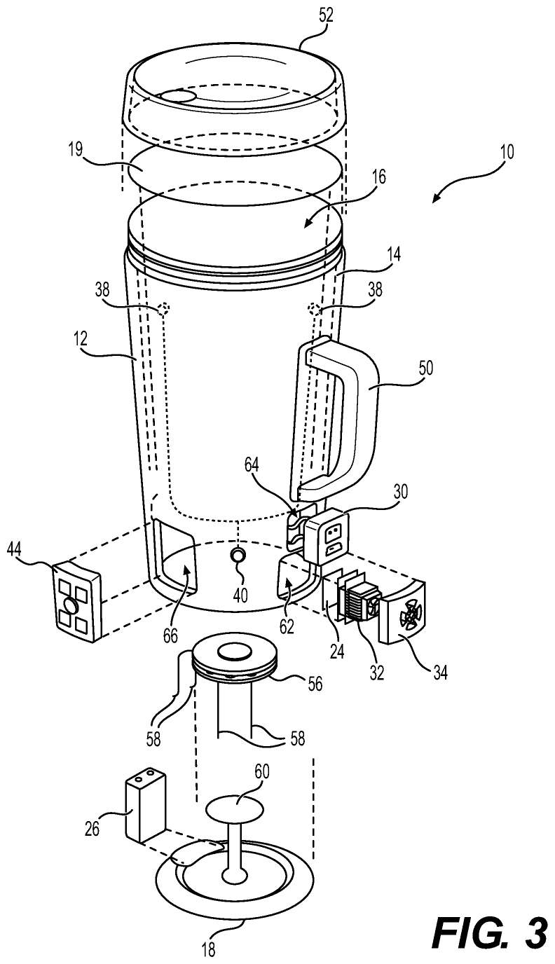

A thermoelectric heat pump 24, such as a Peltier device or the like, is mounted in the lower portion 22 of the container body 12. At least one battery 26 and a controller 28 are also mounted within the lower portion 22 of the container body 12. Although FIGS. 2 and 3 show a single 9V battery, it should be understood that this single 9V battery is shown for exemplary purposes only, and that any suitable type of battery, and any suitable number of batteries, may be used. It should be understood that any suitable type of thermoelectric device may be used for heating and cooling the beverage. A Peltier device is capable of generating temperatures as low as −50° C. and as high 70° C.

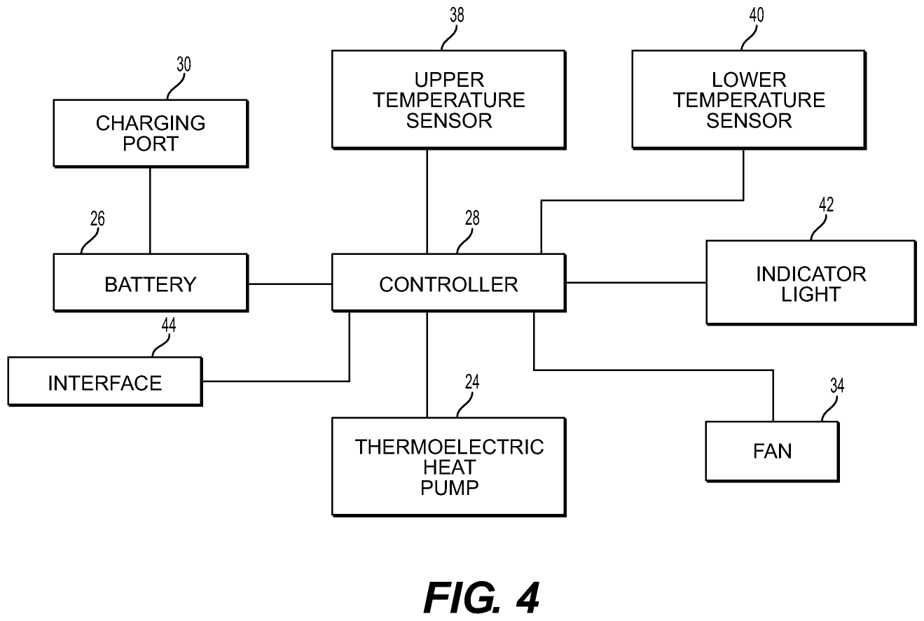

As illustrated in FIG. 4, the at least one battery 26 is in electrical communication with the thermoelectric heat pump 24 through the controller 28, such that the controller 28 can selectively switch polarity of the thermoelectric heat pump 24 to selectively alternate between heating and cooling of the lower portion 22 of the container body 12. It should be understood that controller 28 may be any suitable type of controller, such as a microprocessor, a programmable logic controller, control circuitry or the like.

A heat exchanger 32 may be in thermal contact with the thermoelectric heat pump 24 for heat exchange with the ambient environment. The heat exchange may be further effected by a fan 34 mounted on the container body 12 adjacent the heat exchanger 32. It should be understood that any suitable type of heat exchanger, such as radiating fins or the like, may be utilized. Additionally, although only a single heat exchanger 32 is shown in FIG. 3, it should be understood that a second heat exchanger may be added such that the thermoelectric heat pump 24 has one heat exchanger adjacent its cold side and one heat exchanger adjacent its hot side.

In FIG. 3, an opening 62 is shown formed through the container body 12 in its lower portion 22, dimensioned and configured for mounting the thermoelectric heat pump 24, heat exchanger 32 and fan 34. It should be understood that the positioning, dimensions and configuration of the opening 62 may vary, depending upon the desired positioning of the thermoelectric heat pump 24, heat exchanger 32 and fan 34, as well as the particular type and style of each of the thermoelectric heat pump 24, heat exchanger 32 and fan 34.

A charging port 30 may be mounted on the container body 12 in electrical communication with the at least one battery 26 for the charging thereof. It should be understood that the charging port 30 is shown in FIGS. 1-3 for exemplary purposes only, and that any suitable type of charging port may be utilized. In FIGS. 1-3, the exemplary charging port 30 is provided with two different types of connector ports, providing two different options for connection to two different types of chargers. It should be understood that the charging port 30 may be provided with any desired number of different types of connector ports. Further, in FIG. 3, an opening 64 is shown formed through the container body 12 in its lower portion 22, dimensioned and configured for mounting the charging port 30. It should be understood that the positioning, dimensions and configuration of the opening 64 may vary, depending upon the desired positioning of the charging port 30, as well as the particular type of charging port.

At least one upper temperature sensor 38 may be mounted on the upper portion 20 of the container body 12. The at least one upper temperature sensor 38 is in electrical communication with the controller 28, such that the controller 28 may control operation of the thermoelectric heat pump 24 based on feedback from the at least one upper temperature sensor 38 to maintain the temperature of the upper portion 20 within a desired temperature range. Additionally, at least one lower temperature sensor 40 may be mounted on the lower portion 22 of the container body 12. The at least one lower temperature sensor 40 is also in electrical communication with the controller 28, such that the controller 28 may control operation of the thermoelectric heat pump 24 based on feedback from the at least one lower temperature sensor 40 to maintain a temperature of the lower portion 22 within a desired temperature range. It should be understood that temperature sensors 38, 40 may be any suitable type of temperature sensor.

An interface 44 may be mounted on the container body 12 in electrical communication with the controller 28, allowing the user to input control parameters, such as basic on-off operations and desired temperatures for the beverage contained in the upper portion 20. In FIGS. 1-3, an exemplary basic multi-button interface 44 is shown, although it should be understood that any suitable type of user interface may be used. Further, in FIG. 3, an opening 66 is shown formed through the container body 12 in its lower portion 22, dimensioned and configured for mounting the interface 44. It should be understood that the positioning, dimensions and configuration of the opening 66 may vary, depending upon the desired positioning of the interface 44, as well as the particular type of interface used. Additionally, as shown in FIG. 1, an indicator light 42 or the like may be provided for indicating the operational status of the heating and cooling beverage container 10; e.g., the operation of the thermoelectric heat pump 24 for heating or cooling the beverage. It should be understood that any suitable type of indicator light may be used, such as a light emitting diode (LED) or the like.

As shown in FIGS. 2 and 3, a hub 56 may be provided in the lower portion 22 for holding any necessary wires 58 or other circuit components. As shown, the hub 56 may be mounted on a pedestal 60 to position the hub 56 out of the way of the at least one battery 26, the thermoelectric heat pump 24 and the other fixed components held within the lower portion 22 of container body 12.

The hub 56 and/or the pedestal 60 may be made from thermally conductive materials such that they may be rapidly heated or cooled via convection currents generated by the fan 34 passing air over the thermoelectric heat pump 24. The positioning of the hub 56 adjacent the inner wall 19 then effects the heating or cooling of the beverage via conduction.

It is to be understood that the heating and cooling beverage container is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A heating and cooling beverage container, comprising:
a container body having at least one sidewall, an open upper end and a closed lower end;
an inner partition wall mounted within the container body and dividing the container body into an upper portion and a lower portion, the upper portion being adapted for receiving and containing a beverage, wherein said at least one sidewall encircles both the upper portion of the container body and the lower portion of the container body and wherein said closed lower end forms a bottom surface of said lower portion;
a thermoelectric heat pump mounted in the lower portion of the container body;
at least one battery mounted in the lower portion of the container body; and
a controller, the at least one battery being in electrical communication with the thermoelectric heat pump through the controller, the controller being configured for selectively switching polarity of the thermoelectric heat pump to selectively alternate between heating and cooling the lower portion of the container body.

2. The heating and cooling beverage container as recited in claim 1, further comprising a heat exchanger in thermal contact with the thermoelectric heat pump for heat exchange with an environment external to the container.

3. The heating and cooling beverage container as recited in claim 2, further comprising a fan mounted on the container body, the fan being positioned adjacent the heat exchanger.

4. The heating and cooling beverage container as recited in claim 1, further comprising a charging port mounted on the container body, the charging port being in electrical communication with the at least one battery.

5. The heating and cooling beverage container as recited in claim 1, further comprising at least one upper temperature sensor mounted on the upper portion of the container body, the at least one upper temperature sensor being in electrical communication with the controller.

6. The heating and cooling beverage container as recited in claim 5, wherein the controller is further configured for controlling operation of the thermoelectric heat pump based on feedback from the at least one upper temperature sensor to maintain temperature in the upper portion within a temperature range between −50° C. and 70° C.

7. The heating and cooling beverage container as recited in claim 1, further comprising at least one lower temperature sensor mounted on the lower portion of the container body, the at least one lower temperature sensor being in electrical communication with the controller.

8. The heating and cooling beverage container as recited in claim 7, wherein the controller is further configured for controlling operation of the thermoelectric heat pump based on feedback from the at least one lower temperature sensor to maintain temperature in the lower portion within a temperature range between −50° C. and 70° C.

9. The heating and cooling beverage container as recited in claim 1, further comprising an interface mounted on the container body, the interface being in electrical communication with the controller for delivering user input to the controller.

10. The heating and cooling beverage container as recited in claim 1, further comprising a handle mounted on the container body.

11. The heating and cooling beverage container as recited in claim 1, further comprising a removable lid releasably covering and sealing the open upper end of the container body.

12. A heating and cooling beverage container, comprising:
a container body having at least one sidewall, an open upper end and a closed lower end;
an inner partition wall mounted within the container body and dividing the container body into an upper portion and a lower portion, the upper portion being adapted for receiving and containing a beverage, wherein said at least one sidewall encircles both the upper portion of the container body and the lower portion of the container body and wherein said closed lower end forms a bottom surface of said lower portion;
a thermoelectric heat pump mounted in the lower portion of the container body;
a heat exchanger in thermal contact with the thermoelectric heat pump for heat exchange with environment external to the container;
at least one battery mounted in the lower portion of the container body; and
a controller, the at least one battery being in electrical communication with the thermoelectric heat pump through the controller, the controller being configured for selectively switching polarity of the thermoelectric heat pump to selectively alternate between heating and cooling the lower portion of the container body.

13. The heating and cooling beverage container as recited in claim 12, further comprising a fan mounted on the container body, the fan being positioned adjacent the heat exchanger.

14. The heating and cooling beverage container as recited in claim 12, further comprising a charging port mounted on the container body, the charging port being in electrical communication with the at least one battery.

15. The heating and cooling beverage container as recited in claim 12, further comprising at least one upper temperature sensor mounted on the upper portion of the container body, the at least one upper temperature sensor being in electrical communication with the controller.

16. The heating and cooling beverage container as recited in claim 15, wherein the controller is further configured for controlling operation of the thermoelectric heat pump based on feedback from the at least one upper temperature sensor to maintain a temperature in the upper portion within a temperature range between −50° C. and 70° C.

17. The heating and cooling beverage container as recited in claim 12, further comprising at least one lower temperature sensor mounted on the lower portion of the container body, the at least one lower temperature sensor being in electrical communication with the controller.

18. The heating and cooling beverage container as recited in claim 17, wherein the controller is further configured for controlling operation of the thermoelectric heat pump based on feedback from the at least one lower temperature sensor to maintain a temperature in the lower portion within a temperature range between −50° C. and 70° C.

19. The heating and cooling beverage container as recited in claim 12, further comprising an interface mounted on the container body, the interface being in electrical communication with the controller for delivering user input thereto.

20. The heating and cooling beverage container as recited in claim 12, further comprising:
a handle fixed to the container body; and
a removable lid releasably covering and sealing the open upper end of the container body.
